(19) United States
(12) Patent Application Publication
(10) Pub. No.: US 2026/0228796 A1
(43) Pub. Date: Aug. 6, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Daiki YOSHIHARA, Tokyo (JP); Jianquan LIU, Tokyo (JP); Noboru YOSHIDA, Tokyo (JP); Takayuki KASE, Tokyo (JP); Takumi OZAKI, Tokyo (JP)

(73) Assignee: NEC Corporation, Tokyo (JP)

(21) Appl. No.: 19/152,016

(22) PCT Filed: Jan. 26, 2024
(86) PCT No.: PCT/JP2024/002457

§ 371 Date: Jul. 30, 2025

(30) Foreign Application Priority Data
Feb. 9, 2023 (JP) 2023-018096

(51) Int. Cl. G06Q 30/0601; G06V 10/70; G06V 10/74; G06V 20/62; G06V 40/10

(52) U.S. Cl. CPC G06Q 30/0631; G06V 10/70; G06V 10/74; G06V 40/10; G06V 20/62

(57) ABSTRACT

The present invention provides an information processing device comprising: a registration unit that registers fashion characteristics for each of a plurality of stores; an image acquisition unit that acquires an image of a customer; an identification unit that identifies the customer's fashion characteristics on the basis of the image of the customer; a determination unit that, on the basis of the fashion characteristics of the plurality of stores and the fashion characteristics of the customer, determines recommended stores to recommend to the customer from among the plurality of stores; and an output unit that outputs information about the recommended stores.

### TECHNICAL FIELD

The present invention relates to an information processing device, an information processing method, and a program.

### BACKGROUND ART

A technique related to the present invention is disclosed in PTL 1. The technique disclosed in PTL 1 acquires behavior information of a user for a first store and attribute information of the user. The technique then extracts a second store based on the acquired behavior information and attribute information, and presents information regarding the extracted second store to the user. The behavior information includes a store visit history, a store leaving history, a purchase history, or the like. The attribute information includes age, gender, whether the user has a family, or the like.

### CITATION LIST

### Patent Literature

PTL 1: JP 2022-150029 A

### SUMMARY OF INVENTION

### Technical Problem

There are many stores that handle fashion products such as clothes, accessories, shoes, bags, hats, glasses, and sunglasses. Since the stores handle different lines of products, a user cannot find a favorite product unless the user goes to a store matching his/her preference. It is not easy to find a store matching one's preference from among a large number of stores. Therefore, there is a demand for a technique of recommending, to a customer, a store that handles fashion products matching the customer's preference.

The technique described in PTL 1 determines a store to be recommended to a customer based on behavior information such as a store visit history, a store leaving history, or a purchase history. The technique is based on the premise that the store visit history, the store leaving history, the purchase history, or the like of each customer is acquired. In a case where these pieces of information cannot be acquired, a store to be recommended to the customer cannot be determined.

In addition, the technique described in PTL 1 determines a store to be recommended to a customer based on attribute information such as age, gender, and whether the customer has a family. However, it is difficult to specify a store that handles fashion products matching the customer's preference only with the attribute information as exemplified.

In view of the above-described problems, an example of an object of the present invention is to provide an information processing device, an information processing method, and a program that solve the problem of implementing a technique of recommending, to a customer, a store that handles fashion products matching the customer's preference.

### Solution to Problem

According to one example aspect of the present invention,
there is provided an information processing device including
a registration means for registering fashion characteristics of each of a plurality of stores,
an image acquisition means for acquiring an image of a customer,
a specification means for specifying fashion characteristics of the customer based on the image of the customer,
a determination means for determining a recommended store to be recommended to the customer from among the plurality of stores based on the fashion characteristics of each of the plurality of stores and the fashion characteristics of the customer, and
an output means for outputting information regarding the recommended store.

According to one example aspect of the present invention,
there is provided an information processing method, wherein
one or more computers
register fashion characteristics of each of a plurality of stores,
acquire an image of a customer,
specify fashion characteristics of the customer based on the image of the customer,
determine a recommended store to be recommended to the customer from among the plurality of stores based on the fashion characteristics of each of the plurality of stores and the fashion characteristics of the customer, and
output information regarding the recommended store.

According to one example aspect of the present invention,
there is provided a program for causing a computer to function as
a registration means for registering fashion characteristics of each of a plurality of stores,
an image acquisition means for acquiring an image of a customer,
a specification means for specifying fashion characteristics of the customer based on the image of the customer,
a determination means for determining a recommended store to be recommended to the customer from among the plurality of stores based on the fashion characteristics of each of the plurality of stores and the fashion characteristics of the customer, and
an output means for outputting information regarding the recommended store.

According to one example aspect of the present invention,
there is provided an information processing device including
an image acquisition means for acquiring an image of a customer and an image of a store associate person of each of a plurality of stores,
a specification means for specifying fashion characteristics of the customer based on the image of the customer, and further specifying fashion characteristics of the store associate person based on the image of the store associate person,
a registration means for registering the fashion characteristics of the store associate person,
a determination means for calculating a matching degree between the customer and the store associate person in a plurality of items included in the fashion characteristics, and determining a recommended store to be recommended to the customer from among the plurality of stores based on a calculation result, and
an output means for outputting information regarding the recommended store.

### Advantageous Effects of Invention

One example aspect of the present invention implements an information processing device, an information processing method, and a program that solve the problem of implementing a technique of recommending, to a customer, a store that handles fashion products matching the customer's preference.

### BRIEF DESCRIPTION OF DRAWINGS

The above-described object and other objects, features, and advantages will be further clarified by the following suitable example embodiments and accompanying drawings.

FIG. 1 It is a diagram illustrating an example of a functional block diagram of an information processing device.

FIG. 2 It is a diagram illustrating an example of a hardware configuration of the information processing device.

FIG. 3 It is a diagram schematically illustrating an example of information processed by the information processing device.

FIG. 4 It is a diagram schematically illustrating an example of other information processed by the information processing device.

FIG. 5 It is a diagram schematically illustrating an example of information output by the information processing device.

FIG. 6 It is a diagram schematically illustrating another example of information output by the information processing device.

FIG. 7 It is a flowchart illustrating an example of a processing flow of the information processing device.

FIG. 8 It is a diagram schematically illustrating an example of other information output by the information processing device.

FIG. 9 It is a diagram schematically illustrating an example of other information processed by the information processing device.

### EXAMPLE EMBODIMENT

Hereinafter, example embodiments of the present invention will be described with reference to the drawings. In all the drawings, similar components are denoted by similar reference numerals, and the description thereof will be omitted as appropriate.

### First Example Embodiment

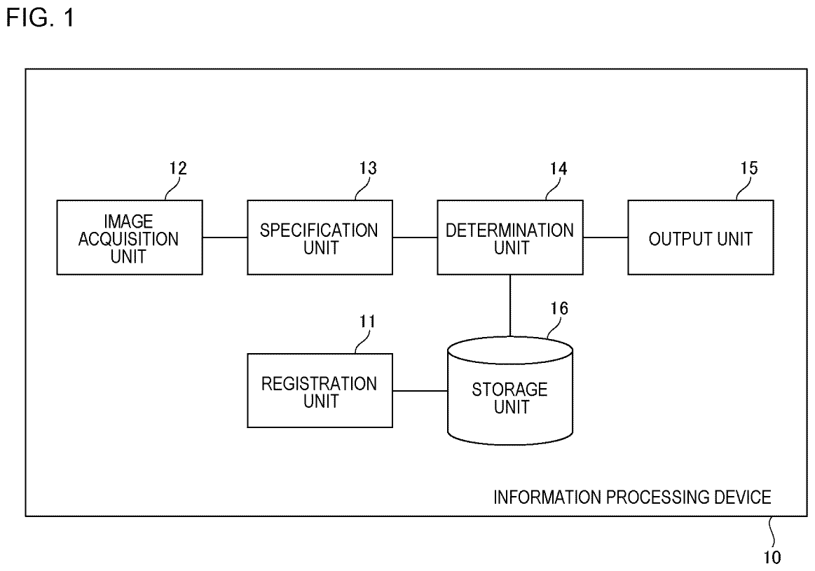

FIG. 1 is a functional block diagram illustrating an outline of an information processing device 10 according to the first example embodiment. The information processing device 10 includes a registration unit 11, an image acquisition unit 12, a specification unit 13, a determination unit 14, an output unit 15, and a storage unit 16. The information processing device 10 does not necessarily include the storage unit 16. In this case, an external device configured to be able to communicate with the information processing device 10 includes the storage unit 16.

The registration unit 11 registers fashion characteristics of each of a plurality of stores. The storage unit 16 stores information indicating the fashion characteristics of each of the plurality of stores. The image acquisition unit 12 acquires an image of a customer. The specification unit 13 specifies fashion characteristics of the customer based on the image of the customer. The determination unit 14 determines a recommended store to be recommended to the customer from among the plurality of stores based on the fashion characteristics of each of the plurality of stores and the fashion characteristics of the customer. The output unit 15 outputs information regarding the recommended store.

In this manner, the information processing device 10 specifies fashion characteristics of a customer based on an image of the customer, and determines a recommended store to be recommended to the customer based on the specification result. The information processing device 10 as described above implements a technique of recommending, to a customer, a store that handles fashion products matching the customer's preference.

### Second Example Embodiment

### Outline

The information processing device 10 of the second example embodiment is obtained by embodying the information processing device 10 of the first example embodiment. That is, the information processing device 10 specifies fashion characteristics of a customer based on an image of the customer, and determines a recommended store to be recommended to the customer based on the specification result.

The information processing device 10 of the second example embodiment is used in, for example, a facility where a plurality of various real stores are gathered (hereinafter, such a facility will be referred to as “collective facility”), such as a department store or a shopping mall. The information processing device 10 acquires an image of a customer of the collective facility. The information processing device 10 then specifies fashion characteristics of the customer based on the image. The information processing device 10 then specifies a store that handles fashion products matching the customer's preference from among the plurality of stores existing in the collective facility, and recommends the store to the customer.

In addition, the information processing device 10 of the second example embodiment is used in, for example, a shopping site where a plurality of online shops (stores) are gathered (hereinafter, such a shopping site will be referred to as “collective shopping site”). The information processing device 10 acquires an image of a customer of the collective shopping site. The information processing device 10 then specifies fashion characteristics of the customer based on the image. The information processing device 10 then specifies an online shop that handles fashion products matching the customer's preference from among the plurality of online shops existing in the collective shopping site, and recommends the online shop to the customer.

### Hardware Configuration

An example of a hardware configuration of the information processing device 10 will be described. Each functional unit of the information processing device 10 is implemented by any combination of hardware and software. It is to be understood by those skilled in the art that there are various modifications of the implementation method and the device. The software includes a program stored in advance from the stage of shipping the device and a program downloaded from a recording medium such as a compact disc (CD), a server on the Internet, or the like.

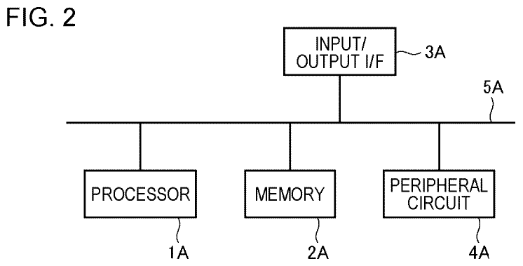

FIG. 2 is a block diagram illustrating a hardware configuration of the information processing device 10. As illustrated in FIG. 2, the information processing device 10 includes a processor 1A, a memory 2A, an input/output interface 3A, a peripheral circuit 4A, and a bus 5A. The peripheral circuit 4A includes various modules. The information processing device 10 does not necessarily include the peripheral circuit 4A. The information processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like and an interface for outputting information to an output device, an external device, an external server, and the like. In addition, the input/output interface 3A includes an interface for connecting to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and perform calculation based on the calculation results.

### Functional Configuration

Next, a functional configuration of the information processing device 10 of the present example embodiment will be described in detail. FIG. 1 illustrates an example of a functional block diagram of the information processing device 10. As illustrated, the information processing device 10 includes the registration unit 11, the image acquisition unit 12, the specification unit 13, the determination unit 14, the output unit 15, and the storage unit 16. The information processing device 10 does not necessarily include the storage unit 16. In this case, an external device configured to be able to communicate with the information processing device 10 includes the storage unit 16.

The registration unit 11 registers fashion characteristics of each of a plurality of stores.

The “stores” are stores that handle fashion products. A store is a concept including a real store and an online shop. For example, the registration unit 11 registers fashion characteristics of each of a plurality of stores existing in a collective facility using the information processing device 10. In addition, the registration unit 11 may register fashion characteristics of each of a plurality of online shops (stores) existing in a collective shopping site using the information processing device 10.

The “fashion products” are products worn or carried by persons, and are products in which not only a function but also an appearance is emphasized. The fashion products include at least one of clothes, accessories, shoes, bags, hats, glasses, and sunglasses. Note that the fashion products are not limited to these examples. Hereinafter, the “fashion products” may be simply referred to as “products”.

The “fashion characteristics of each store” are fashion characteristics of products handled by each store.

The “fashion characteristics” include any of a fashion style, a brand, a design, a hairstyle, and a makeup style. The fashion characteristics include, for example, such a plurality of items.

The “fashion style” is a style of fashion, and includes, for example, a street style, a mode style, and a clean-cut style, but is not limited thereto. The registration unit 11 registers a fashion style of a product handled by each store in association with the store.

The “brand” is a brand of a product. The registration unit 11 registers a brand of a product handled by each store in association with the store.

The “design” is indicated by the shape, size, color, figure, pattern, or the like of a product. The registration unit 11 registers a design of a product handled by each store in association with the store.

The “hairstyle” includes short hair, long hair, shoulder-length hair, afro, mohawk, and the like, but is not limited thereto. The registration unit 11 registers a hairstyle suitable for a product handled by each store in association with the store.

The “makeup style” includes natural-look makeup, mode makeup, and the like, but is not limited thereto. The registration unit 11 registers a makeup style suitable for a product handled by each store in association with the store.

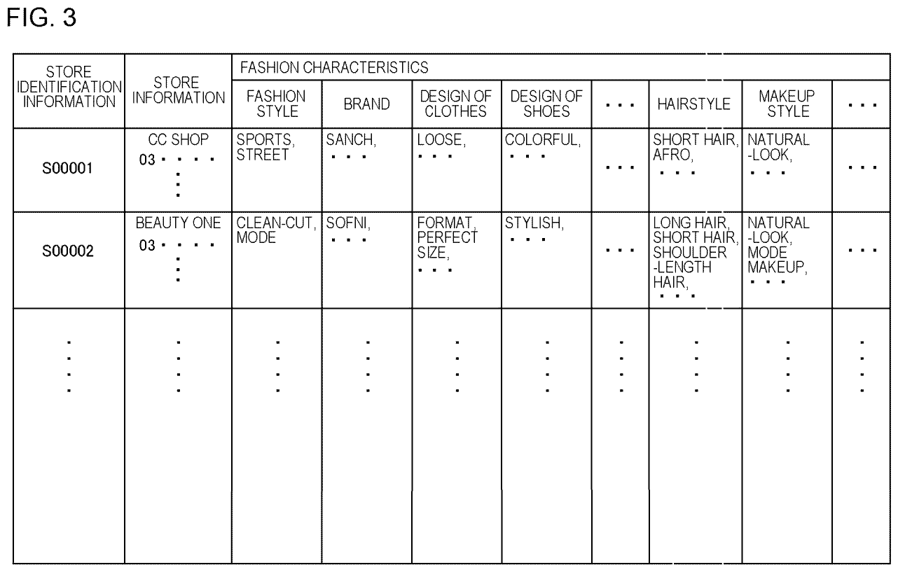

The information registered by the registration unit 11 is stored in the storage unit 16. FIG. 3 illustrates an example of information stored in the storage unit 16. In the illustrated information, store identification information, store information, and the above-described fashion characteristics are associated with each other.

The “store identification information” is information for identifying a plurality of stores existing in a collective facility (or in a collective shopping site) using the information processing device 10.

The “store information” is information regarding each store. The store information may include at least one of a store name, a telephone number, a location, and information regarding products that the store handles (brands that the store handles, types of products that the store handles, or the like). The location may be information indicating a location in the collective facility. The location may be information indicating a location (URL or the like) in the collective shopping site.

The registration unit 11 can register information as illustrated in FIG. 3 based on a user input. That is, a user inputs store information and fashion characteristics of each store via an input device such as a keyboard, a mouse, a touch panel, a microphone, or a physical button. The registration unit 11 registers the information input by the user in this manner. The registration unit 11 can also register the fashion characteristics of each store using other methods described in the third example embodiment.

Returning to FIG. 1, the image acquisition unit 12 acquires an image of a customer.

For example, a customer terminal may be installed at any position in the collective facility. The customer terminal includes a camera, a display, an input device (keyboard, mouse, touch panel, microphone, physical button, or the like), and a communication means. The customer terminal captures an image of a customer. The customer terminal then transmits the image of the customer to the information processing device 10. The image acquisition unit 12 may acquire the image of the customer transmitted from the customer terminal in this manner.

In addition, the collective facility may receive an upload of an image of a customer via a dedicated web page or application. The customer captures an image of himself/herself using his/her imaging device (camera, smartphone, mobile phone, or the like). The customer then uploads the captured image (image of the customer) to a server of the collective facility by using his/her client terminal (smartphone, personal computer, tablet terminal, mobile phone, or the like). The image acquisition unit 12 may acquire the image of the customer uploaded to the server in this manner.

In addition, the collective shopping site may instruct a customer to upload an image of the customer. The customer captures an image of himself/herself using his/her imaging device (camera, smartphone, mobile phone, or the like). The customer then accesses the collective shopping site using his/her client terminal (smartphone, personal computer, tablet terminal, mobile phone, or the like). Thereafter, the customer uploads the captured image (image of the customer) to the collective shopping site (server) in accordance with the above instruction. The image acquisition unit 12 may acquire the image of the customer uploaded to the collective shopping site in this manner.

The specification unit 13 described below specifies fashion characteristics of the customer based on the image of the customer. Therefore, the image of the customer is preferably an image showing the entire body of the customer. For example, a customer terminal installed in the collective facility, a web page or an application dedicated to the collective facility, the collective shopping site, or the like may instruct the customer to capture or upload an image showing the entire body of the customer. Note that an image showing a part of the body of the customer, such as the upper body, the lower body, or a part lower than the neck of the customer, may be used as the image of the customer. Even in such a case, the fashion characteristics of the customer can be specified from a fashion product related to the part of the body.

Based on the image of the customer acquired by the image acquisition unit 12, the specification unit 13 specifies the fashion characteristics of the customer. As described above, the fashion characteristics include any of the fashion style, the brand, the design, the hairstyle, and the makeup style.

For example, the specification unit 13 can specify a fashion style of the customer based on the appearance of the customer appearing in the image. In addition, the specification unit 13 may specify a brand or a design of clothes worn by the customer appearing in the image. The specification unit 13 may specify a brand or a design of belongings possessed by the customer appearing in the image. The belongings are fashion-related belongings, and include, for example, accessories, shoes, bags, hats, glasses, and sunglasses, but are not limited thereto. The specification unit 13 may specify a hairstyle of the customer appearing in the image. In addition, the specification unit 13 may specify a makeup style of the customer appearing in the image. Hereinafter, specific examples of processing by the specification unit 13 will be described.

### Fashion Style Specifying Processing Example 1

As an example, the specification unit 13 can specify a fashion style of a person appearing in an image based on an estimation model generated by machine learning. The estimation model is generated as follows, for example. First, learning data is prepared in which an image of a person and a name of a fashion style of the person are paired. An estimation model is then generated by machine learning based on the learning data.

The learning data is prepared by any method. Hereinafter, an example will be described, but the present invention is not limited thereto. First, images of persons are collected. For example, images of persons may be collected from images on the Internet, images of a monitoring camera, or the like. The collected images are grouped by a known clustering technique based on feature amounts (brands, designs, or the like) of clothes or belongings. Each group is then given a label (fashion style).

Labeling may be performed by a person. In addition, labeling may be automatically performed. Hereinafter, an example of processing of automatically performing labeling will be described. For example, it is assumed that images captured by a monitoring camera at a place where people of a first fashion style gather (for example, a place where many stores of the first fashion style gather) are collected. In this case, clustering is performed only for the images captured by the monitoring camera. The group having the largest number of members (number of images) is labeled with the first fashion style.

### Fashion Style Specifying Processing Example 2

In addition, the specification unit 13 may specify a fashion style of a person appearing in an image based on at least one of a brand of clothes, a design of clothes, a brand of belongings, a design of belongings, a hairstyle, and a makeup style of the person appearing in the image.

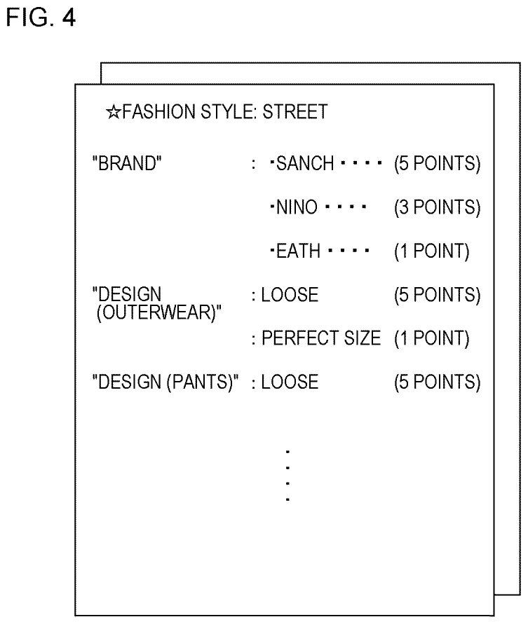

For example, as illustrated in FIG. 4, score calculation criteria may be stored in the information processing device 10 for each fashion style. The illustrated score calculation criteria indicate scores to be added in a case where fashion characteristics of a person appearing in an image have a predetermined feature. The feature is defined in at least one of a brand of clothes, a design of clothes, a brand of belongings, a design of belongings, a hairstyle, and a makeup style. In FIG. 4, it is shown that five points are added in a case where the brand of the clothes or belongings of the person in the image is “SANCH”. Although not illustrated, scores to be deducted in a case of having a predetermined feature may be indicated.

The specification unit 13 then refers to the score calculation criteria for each fashion style for each fashion style, and specifies a feature of the person appearing in the image from among the features indicated by the score calculation criteria. Next, the specification unit 13 calculates a total score obtained by summing scores associated to one or a plurality of specified features for each fashion style. The specification unit 13 then specifies a fashion style whose total score exceeds a threshold as a fashion style of the customer.

### Other Specifying Processing

A brand of clothes and a brand of belongings are specified by detection of a logo of each brand and a design specific to each brand from an image. These feature amounts may be stored in the information processing device 10 in advance. The specification unit 13 may specify the brand by detecting a feature amount from the image. Note that the specification unit 13 may specify the brand by using an estimation model generated by machine learning.

The specification unit 13 can also specify a design of clothes and belongings, a hairstyle, and a makeup style by a technique such as detection of a feature amount registered in advance or use of an estimation model generated by machine learning.

Returning to FIG. 1, the determination unit 14 determines a recommended store to be recommended to the customer from among the plurality of stores based on the fashion characteristics of each of the plurality of stores (see FIG. 3) and the fashion characteristics of the customer specified by the specification unit 13. The determination unit 14 may determine one of the plurality of stores as a recommended store. The determination unit 14 may determine two or more of the plurality of stores as recommended stores.

For example, the determination unit 14 can determine at least one of the following stores 1 to 3 as a recommended store.
(Store 1) A store in which contents of a previously-designated important item among a plurality of items included in the fashion characteristics match the customer
(Store 2) A store in which contents of a predetermined number or more or a predetermined proportion or more of a plurality of items included in the fashion characteristics match the customer
(Store 3) A store in which a score calculated based on the matching degree of contents with the customer in a plurality of items included in the fashion characteristics satisfies a predetermined condition

First, the store 1 will be described. The fashion characteristics include a plurality of items such as the fashion style, the brand, the design, the hairstyle, and the makeup style. One or more of such items are designated in advance as important items. The store 1 is a store in which the contents of such important items match the customer. The important items may be common to all stores. In addition, the important items may be determined for each store.

As illustrated in FIG. 3, fashion characteristics of a store can include a plurality of contents in each item. For example, a fashion style of one store can include a plurality of contents such as street and sports. “Matching of contents of an item” means that the contents of the item of the customer are included in the contents of the item of the store. For example, it is assumed that the contents of a fashion style of a certain store include street and sports. In addition, it is assumed that the contents of a fashion style of a certain customer is street. In this case, the contents of this store and this customer in the fashion style match each other.

Next, the store 2 will be described. The fashion characteristics include a plurality of items such as the fashion style, the brand, the design, the hairstyle, and the makeup style. The store 2 is a store in which the contents of a predetermined number or more or a predetermined proportion or more of such a plurality of items match the customer. The predetermined number and the predetermined proportion are predetermined values. The predetermined number and the predetermined proportion may be common to all stores. In addition, the predetermined number and the predetermined proportion may be determined for each store.

Next, the store 3 will be described. The fashion characteristics include a plurality of items such as the fashion style, the brand, the design, the hairstyle, and the makeup style. The determination unit 14 determines whether the contents of the store and the customer match each other for each item. The determination unit 14 calculates a score of the matching degree based on the result. For example, a weighting value may be set in advance for each item. The determination unit 14 may calculate the sum of the weighting values of the items whose contents match as the score of the matching degree. The store 3 is, for example, a store in which the matching degree calculated in this manner satisfies a predetermined condition (for example, equal to or higher than a threshold). The weighting value for each item may be common to all stores. In addition, the weighting value for each item may be determined for each store. The predetermined condition of the matching degree may be common to all stores. In addition, the predetermined condition of the matching degree may be determined for each store.

The output unit 15 outputs information regarding the recommended store determined by the determination unit 14. The information regarding the recommended store is information included in the store information (see FIG. 3).

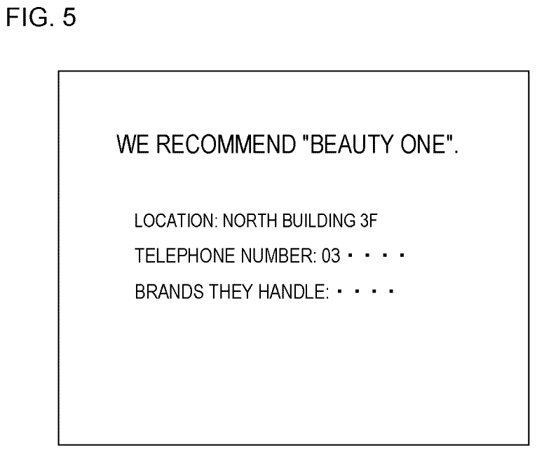

For example, the output unit 15 may transmit the information regarding the recommended store to a customer terminal installed at any position in the above-described collective facility. As illustrated in FIG. 5, the customer terminal displays the received information regarding the recommended store on the display. Although one recommended store is displayed in FIG. 5, two or more recommended stores may be displayed.

In addition, the output unit 15 may transmit the information regarding the recommended store to the client terminal that has uploaded the image of the customer via the dedicated web page or application of the collective facility. As illustrated in FIG. 5, the client terminal displays the received information regarding the recommended store on the display. Although one recommended store is displayed in FIG. 5, two or more recommended stores may be displayed.

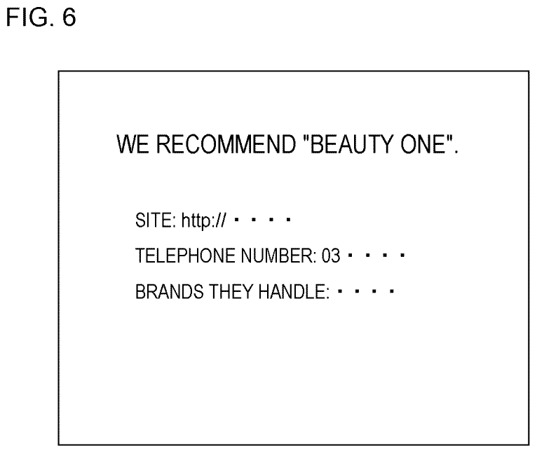

In addition, the output unit 15 may transmit the information regarding the recommended store to the collective shopping site (server). The collective shopping site transmits the received information regarding the recommended store to the client terminal that has accessed the site and has uploaded the image of the customer. As illustrated in FIG. 6, the client terminal displays the received information regarding the recommended store on the display. Although one recommended store is displayed in FIG. 6, two or more recommended stores may be displayed.

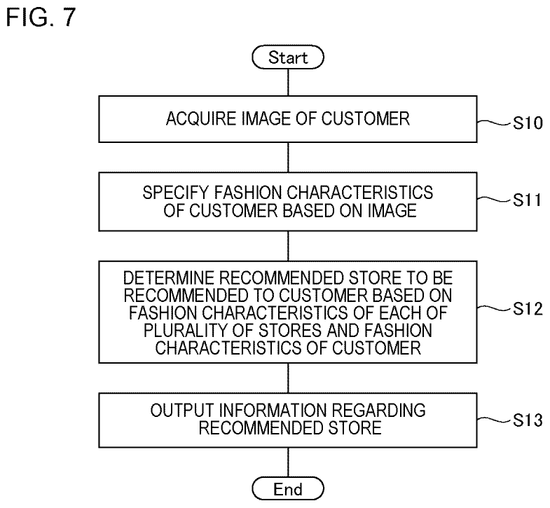

Next, an example of a processing flow of the information processing device 10 will be described with reference to the flowchart of FIG. 7. First, before the processing of the flowchart of FIG. 7 is executed, the information processing device 10 registers fashion characteristics of each of a plurality of stores. As a result, information regarding the fashion characteristics of each of the plurality of stores is stored in the storage unit 16 (see FIG. 3). The fashion characteristics include any of the fashion style, the brand, the design, the hairstyle, and the makeup style.

Based on such a premise, when acquiring an image of a customer (S10), the information processing device 10 specifies fashion characteristics of the customer based on the image of the customer (S11). For example, the information processing device 10 can specify a fashion style of the customer based on the appearance of the customer appearing in the image. In addition, the information processing device 10 may specify a brand or a design of clothes worn by the customer appearing in the image. The information processing device 10 may specify a brand or a design of belongings possessed by the customer appearing in the image. The information processing device 10 may specify a hairstyle of the customer appearing in the image. The information processing device 10 may specify a makeup style of the customer appearing in the image.

Next, the information processing device 10 determines a recommended store to be recommended to the customer from among the plurality of stores based on the fashion characteristics of each of the plurality of stores registered in advance and the fashion characteristics of the customer specified in S11 (S12). For example, the information processing device 10 can determine at least one of the above-described stores 1 to 3 as a recommended store.

The information processing device 10 then outputs information regarding the recommended store (S13). As a result, as illustrated in FIGS. 5 and 6, the information regarding the recommended store is presented to the customer.

### Functions and Effects

According to the information processing device 10 of the second example embodiment, functions and effects similar to those of the information processing device 10 of the first example embodiment are implemented.

The information processing device 10 specifies fashion characteristics of a customer by image analysis, and determines a recommended store to be recommended to the customer based on the specification result. The information processing device 10 as described above is only required to acquire an image of a customer in determining a recommended store to be recommended to the customer, and does not need various types of data (store visit history, store leaving history, purchase history, and the like for each store) registered in association with each customer. Therefore, it is not necessary to specify the customer by user authentication processing or the like. As a result, the customer can easily use the service without worrying about privacy problems or the like.

The fashion characteristics of the customer specified by the image analysis include characteristic contents such as a fashion style, a brand, a design, a hairstyle, and a makeup style. The information processing device 10 then determines a recommended store to be recommended to the customer based on such characteristic fashion characteristics. Therefore, the information processing device 10 can accurately recommend, to the customer, a store that handles fashion products matching the customer's preference.

The information processing device 10 can specify a fashion style of a person appearing in an image based on an estimation model generated by machine learning. Furthermore, the information processing device 10 can specify the fashion style of the person appearing in the image based on at least one of a brand of clothes, a design of clothes, a brand of belongings, a design of belongings, a hairstyle, and a makeup style of the person appearing in the image. Therefore, the information processing device 10 can accurately specify the fashion style of the person appearing in the image.

The information processing device 10 can determine at least one of the above-described stores 1 to 3 as a recommended store. Therefore, the information processing device 10 can accurately recommend, to the customer, a store that handles fashion products matching the customer's preference.

### Third Example Embodiment

The information processing device 10 of the third example embodiment registers fashion characteristics of each store by characteristic processing. Details will be described below.

The image acquisition unit 12 acquires an image of a store associate person of each store. The store associate person includes any of a mannequin installed in each store, a store clerk of each store, and a visitor in each store. The mannequin installed in each store and the store clerk of each store wear products handled in the store.

The image acquisition unit 12 can acquire an image of a store associate person of each store by any means. For example, an image captured by a monitoring camera that is installed in a real store and captures a store associate person in the store may be input to the information processing device 10 by any means. In addition, a store clerk of a real store may capture an image of a store associate person using an imaging device (camera, smartphone, mobile phone, or the like) and input the captured image to the information processing device 10 by any means.

As described below, the specification unit 13 specifies fashion characteristics of the store associate person based on the image of the store associate person. Therefore, the image of the store associate person is preferably an image showing the entire body of the store associate person. Note that an image showing a part of the body of the store associate person, such as the upper body, the lower body, or a part lower than the neck of the store associate person, may be used as the image of the store associate person. Even in such a case, the fashion characteristics of the store associate person can be specified from a fashion product related to the part.

The specification unit 13 specifies the fashion characteristics of the store associate person based on the image of the store associate person. The specification unit 13 can specify the fashion characteristics of the store associate person based on the image of the store associate person by processing similar to the processing of specifying fashion characteristics of a customer based on an image of the customer.

The registration unit 11 registers the fashion characteristics of the store associate person specified by the specification unit 13 as fashion characteristics of each store.

For example, the registration unit 11 can register fashion characteristics of the mannequin installed in each store as fashion characteristics of each store. The registration unit 11 can register fashion characteristics of the store clerk of each store as fashion characteristics of each store. The image acquisition unit 12 may acquire images of a plurality of store associate persons (a plurality of mannequins or a plurality of store clerks) associated to each store. In this case, the registration unit 11 may register fashion characteristics of at least one of the plurality of store associate persons as fashion characteristics of each store. In addition, the registration unit 11 may register fashion characteristics of a predetermined number or more or a predetermined proportion or more of the plurality of store associate persons as fashion characteristics of each store.

In the case of using fashion characteristics of the visitor in each store, the registration unit 11 may perform the following processing. For example, the registration unit 11 may register, as fashion characteristics of each store, fashion characteristics of a predetermined number or more of visitors or a predetermined proportion or more of visitors among the visitors who have visited the store in a target period (for example, within the last one year or the like).

Other configurations of the information processing device 10 are similar to the configurations of the information processing devices 10 of the first and second example embodiments.

According to the information processing device 10 of the third example embodiment, functions and effects similar to those of the information processing devices 10 of the first and second example embodiments are implemented.

According to the information processing device 10 of the third example embodiment, inputting an image of a store associate person of each store to the information processing device 10 makes it possible to register fashion characteristics of each store. According to the information processing device 10 as described above, the fashion characteristics of each store can be efficiently registered with high accuracy.

### Fourth Example Embodiment

The information processing device 10 of the fourth example embodiment is a combination of the configuration of the information processing device 10 of the second example embodiment and the configuration of the information processing device 10 of the third example embodiment.

The image acquisition unit 12 acquires an image of a store associate person of each of a plurality of stores. The specification unit 13 specifies fashion characteristics of the store associate person based on the image of the store associate person. The registration unit 11 registers the fashion characteristics of the store associate person specified by the specification unit 13 as fashion characteristics of the store. The processing is as described in the third example embodiment.

The image acquisition unit 12 acquires an image of a customer. The specification unit 13 specifies fashion characteristics of the customer based on the image of the customer. The processing is as described in the second example embodiment.

The determination unit 14 then determines a recommended store to be recommended to the customer from among the plurality of stores based on the fashion characteristics of each of the plurality of stores and the fashion characteristics of the customer. Specifically, the determination unit 14 calculates the matching degree between the customer and the store associate person in a plurality of items included in the fashion characteristics, and determines a recommended store to be recommended to the customer from among the plurality of stores based on the calculation result (the matching degree). This processing corresponds to the processing of determining the store 3 as a recommended store, which has been described in the second example embodiment.

The output unit 15 outputs information regarding the recommended store. The processing is as described in the second example embodiment.

According to the information processing device 10 of the fourth example embodiment, functions and effects similar to those of the information processing devices 10 of the first to third example embodiments are implemented.

### MODIFICATIONS

Hereinafter, modifications applicable to the first to fourth example embodiments will be described.

### First Modification

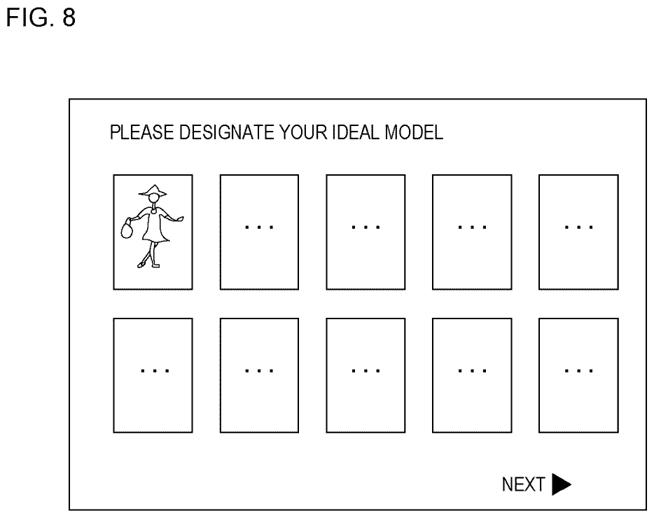

In the first modification, as illustrated in FIG. 8, the information processing device 10 presents images of a plurality of models to a customer in a selectable manner, and receives an input for designating an image of a desired model from among the images. The plurality of models have different fashion characteristics.

For example, a customer terminal installed at any position in a collective facility may present information as illustrated in FIG. 8 and receive an input for designating a desired model. The customer terminal may transmit the received designation contents to the information processing device 10. In addition, the presentation of information as illustrated in FIG. 8 and the reception of an input for designating a desired model may be performed via a dedicated web page or application (server) of the collective facility. The server may transmit the received designation contents to the information processing device 10. In addition, the presentation of information as illustrated in FIG. 8 and the reception of an input for designating a desired model may be performed in a collective shopping site. The collective shopping site (server) may transmit the received designation contents to the information processing device 10.

The determination unit 14 determines a recommended store to be recommended to the customer from among a plurality of stores based on fashion characteristics of each of the plurality of stores registered by the registration unit 11, fashion characteristics of the customer specified by the specification unit 13, and fashion characteristics of the model designated by the customer.

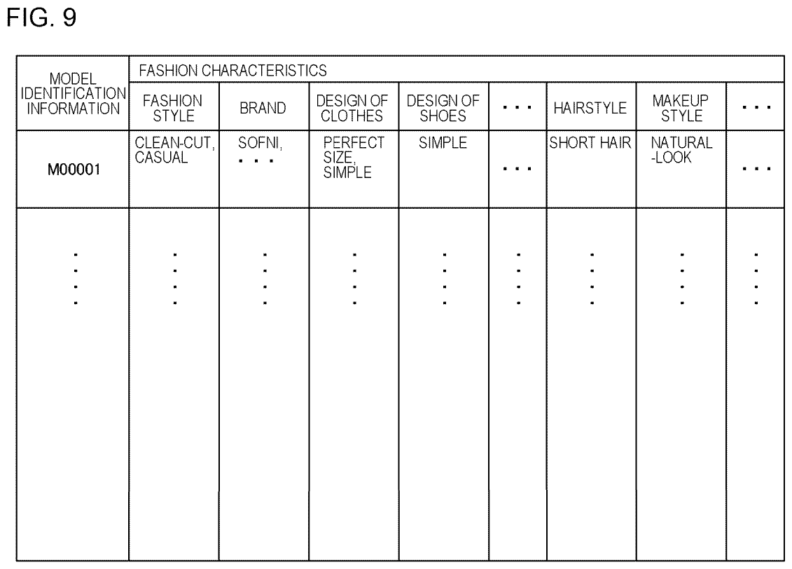

As illustrated in FIG. 9, information indicating fashion characteristics of each of the plurality of models is stored in the storage unit 16 in advance. The determination unit 14 specifies the fashion characteristics of the model designated by the customer based on the information.

For example, the determination unit 14 specifies contents that are not included in the fashion characteristics of the customer among the fashion characteristics of the model designated by the customer. For example, the determination unit 14 specifies a brand that is not included in the fashion characteristics of the customer among the brands included in the fashion characteristics of the model. The determination unit 14 can determine a store including the specified fashion characteristics as a recommended store.

As described above, the information processing device 10 of the first modification can specify, for example, fashion characteristics that are included in a model designated by a customer and are not included in the customer, and can recommend a store having the specified fashion characteristics to the customer. The customer can purchase a product to approach the designated model at the recommended store.

In addition, for example, the determination unit 14 may specify contents included in the fashion characteristics of the customer among the fashion characteristics of the model designated by the customer. For example, the determination unit 14 specifies a brand included in the fashion characteristics of the customer among the brands included in the fashion characteristics of the model. The determination unit 14 may determine a store including the specified fashion characteristics as a recommended store.

As described above, the information processing device 10 of the first modification can specify, for example, fashion characteristics included in both a model designated by a customer and the customer, and can recommend a store having the specified fashion characteristics to the customer. Extracting a common point between the fashion characteristics of the customer and the fashion characteristics of the model designated by the customer makes it possible to specify the customer's preference more accurately.

### Second Modification

In the second modification, in a case where a model is designated by a customer as described in the first modification, the information processing device 10 determines a recommended store by the method described in the first modification. In a case where no model is designated by the customer, the information processing device 10 determines a recommended store by the methods described in the first to fourth example embodiments.

Although the example embodiments of the present invention have been described above with reference to the drawings, these are examples of the present invention, and various configurations other than the above can be adopted. The configurations of the above-described example embodiments may be combined with each other, or some configurations may be replaced with other configurations. In addition, various modifications may be made to the configurations of the above-described example embodiments within a range not departing from the gist. In addition, the configurations and processing disclosed in the above-described example embodiments and modifications may be combined with each other.

In the flowchart used in the above description, a plurality of steps (processing) are described in order. However, the execution order of the steps executed in each example embodiment is not limited to the described order. In each example embodiment, the order of the illustrated steps can be changed within a range in which there is no problem in terms of contents. The above-described example embodiments can be combined within a range in which the contents are not contradictory.

Some or all of the above example embodiments may be described as the following supplementary notes, but are not limited to the following.

1. An information processing device including:
a registration means for registering fashion characteristics of each of a plurality of stores;
an image acquisition means for acquiring an image of a customer;
a specification means for specifying fashion characteristics of the customer based on the image of the customer;
a determination means for determining a recommended store to be recommended to the customer from among the plurality of stores based on the fashion characteristics of each of the plurality of stores and the fashion characteristics of the customer; and
an output means for outputting information regarding the recommended store.

2. The information processing device according to 1, wherein
the image acquisition means acquires an image of a store associate person including any of a mannequin installed in each store, a store clerk of each store, and a visitor in each store,
the specification means specifies fashion characteristics of the store associate person based on the image of the store associate person, and
the registration means registers the specified fashion characteristics of the store associate person as fashion characteristics of each store.

3. The information processing device according to 1 or 2, wherein the fashion characteristics include any of a fashion style, a brand, a design, a hairstyle, and a makeup style.

4. The information processing device according to 3, wherein the specification means specifies a fashion style of a person appearing in an image based on an estimation model generated by machine learning.

5. The information processing device according to 3, wherein the specification means specifies a fashion style of a person appearing in an image based on at least one of a brand of clothes, a design of clothes, a brand of belongings, a design of belongings, a hairstyle, and a makeup style of the person appearing in the image.

6. The information processing device according to any of 1 to 5, wherein
the fashion characteristics include a plurality of items, and
the determination means
determines, as the recommended store, at least one of
a store in which contents of a previously-designated important item among the plurality of items match the customer,
a store in which contents of a predetermined number or more or a predetermined proportion or more of the plurality of items match the customer, and
a store in which a score calculated based on a matching degree of contents with the customer in each of the plurality of items satisfies a predetermined condition.

7. An information processing method wherein
one or more computers
register fashion characteristics of each of a plurality of stores,
acquire an image of a customer,
specify fashion characteristics of the customer based on the image of the customer,
determine a recommended store to be recommended to the customer from among the plurality of stores based on the fashion characteristics of each of the plurality of stores and the fashion characteristics of the customer, and
output information regarding the recommended store.

8. A program for causing a computer to function as:
a registration means for registering fashion characteristics of each of a plurality of stores;
an image acquisition means for acquiring an image of a customer;
a specification means for specifying fashion characteristics of the customer based on the image of the customer;
a determination means for determining a recommended store to be recommended to the customer from among the plurality of stores based on the fashion characteristics of each of the plurality of stores and the fashion characteristics of the customer; and
an output means for outputting information regarding the recommended store.

9. An information processing device including:
an image acquisition means for acquiring an image of a customer and an image of a store associate person of each of a plurality of stores;
a specification means for specifying fashion characteristics of the customer based on the image of the customer, and further specifying fashion characteristics of the store associate person based on the image of the store associate person;
a registration means for registering the fashion characteristics of the store associate person;
a determination means for calculating a matching degree between the customer and the store associate person in a plurality of items included in the fashion characteristics, and determining a recommended store to be recommended to the customer from among the plurality of stores based on a calculation result; and
an output means for outputting information regarding the recommended store.

This application is based upon and claims the benefit of priority from Japanese patent application No. 2023-018096, filed on Feb. 9, 2023, the disclosure of which is incorporated herein in its entirety by reference.

### REFERENCE SIGNS LIST

10 information processing device
11 registration unit
12 image acquisition unit
13 specification unit
14 determination unit
15 output unit
16 storage unit
1A processor
2A memory
3A input/output I/F
4A peripheral circuit
5A bus

What is claimed is:

1. An information processing apparatus comprising:
at least one memory configured to store one or more instructions; and
at least one processor configured to execute the one or more instructions to:
register fashion characteristics of each of a plurality of stores;
acquire an image of a customer;
specify fashion characteristics of the customer based on the image of the customer;
determine a recommended store to be recommended to the customer from among the plurality of stores based on the fashion characteristics of each of the plurality of stores and the fashion characteristics of the customer; and
output information regarding the recommended store.

2. The information processing apparatus according to claim 1, wherein the at least one processor is further configured to execute the one or more instructions to
acquire an image of a store associate person including any of a mannequin installed in each store, a store clerk of each store, and a visitor in each store,
specify fashion characteristics of the store associate person based on the image of the store associate person, and
register the specified fashion characteristics of the store associate person as fashion characteristics of each store.

3. The information processing apparatus according to claim 1, wherein the fashion characteristics include any of a fashion style, a brand, a design, a hairstyle, and a makeup style.

4. The information processing apparatus according to claim 3, wherein the at least one processor is further configured to execute the one or more instructions to specify a fashion style of a person appearing in an image based on an estimation model generated by machine learning.

5. The information processing apparatus according to claim 3, wherein the at least one processor is further configured to execute the one or more instructions to specify a fashion style of a person appearing in an image based on at least one of a brand of clothes, a design of clothes, a brand of belongings, a design of belongings, a hairstyle, and a makeup style of the person appearing in the image.

6. The information processing apparatus according to claim 1, wherein
the fashion characteristics include a plurality of items, and
the at least one processor is further configured to execute the one or more instructions to
determine, as the recommended store, at least one of
a store in which contents of a previously-designated important item among the plurality of items match the customer,
a store in which contents of a predetermined number or more or a predetermined proportion or more of the plurality of items match the customer, and
a store in which a score calculated based on a matching degree of contents with the customer in each of the plurality of items satisfies a predetermined condition.

7. An information processing method, wherein
one or more computers
register fashion characteristics of each of a plurality of stores,
acquire an image of a customer,
specify fashion characteristics of the customer based on the image of the customer,
determine a recommended store to be recommended to the customer from among the plurality of stores based on the fashion characteristics of each of the plurality of stores and the fashion characteristics of the customer, and
output information regarding the recommended store.

8. The information processing method according to claim 7, wherein
the one or more computers
acquire an image of a store associate person including any of a mannequin installed in each store, a store clerk of each store, and a visitor in each store,
specify fashion characteristics of the store associate person based on the image of the store associate person, and
register the specified fashion characteristics of the store associate person as fashion characteristics of each store.

9. The information processing method according to claim 7, wherein the fashion characteristics include any of a fashion style, a brand, a design, a hairstyle, and a makeup style.

10. The information processing method according to claim 9, wherein the one or more computers specify a fashion style of a person appearing in an image based on an estimation model generated by machine learning.

11. The information processing method according to claim 9, wherein the one or more computers specify a fashion style of a person appearing in an image based on at least one of a brand of clothes, a design of clothes, a brand of belongings, a design of belongings, a hairstyle, and a makeup style of the person appearing in the image.

12. The information processing method according to claim Z, wherein
the fashion characteristics include a plurality of items, and
the one or more computers
determine, as the recommended store, at least one of
a store in which contents of a previously-designated important item among the plurality of items match the customer,
a store in which contents of a predetermined number or more or a predetermined proportion or more of the plurality of items match the customer, and
a store in which a score calculated based on a matching degree of contents with the customer in each of the plurality of items satisfies a predetermined condition.

13. A non-transitory computer-readable medium storing a program for causing a computer to:
register fashion characteristics of each of a plurality of stores;
acquire an image of a customer;
specify fashion characteristics of the customer based on the image of the customer;
determine a recommended store to be recommended to the customer from among the plurality of stores based on the fashion characteristics of each of the plurality of stores and the fashion characteristics of the customer; and
output information regarding the recommended store.

14. The non-transitory computer-readable medium according to claim 13, wherein the program causes the computer to
acquire an image of a store associate person including any of a mannequin installed in each store, a store clerk of each store, and a visitor in each store,
specify fashion characteristics of the store associate person based on the image of the store associate person, and
register the specified fashion characteristics of the store associate person as fashion characteristics of each store.

15. The non-transitory computer-readable medium according to claim 13, wherein the fashion characteristics include any of a fashion style, a brand, a design, a hairstyle, and a makeup style.

16. The non-transitory computer-readable medium according to claim 15, wherein the program causes the computer to specify a fashion style of a person appearing in an image based on an estimation model generated by machine learning.

17. The non-transitory computer-readable medium according to claim 15, wherein the program causes the computer to specify a fashion style of a person appearing in an image based on at least one of a brand of clothes, a design of clothes, a brand of belongings, a design of belongings, a hairstyle, and a makeup style of the person appearing in the image.

18. The non-transitory computer-readable medium according to claim 13, wherein
the fashion characteristics include a plurality of items, and
the program causes the computer to
determine, as the recommended store, at least one of
a store in which contents of a previously-designated important item among the plurality of items match the customer,
a store in which contents of a predetermined number or more or a predetermined proportion or more of the plurality of items match the customer, and
a store in which a score calculated based on a matching degree of contents with the customer in each of the plurality of items satisfies a predetermined condition.

19-20. (canceled)
